(19) United States
(12) Patent Application Publication
(10) Pub. No.: US 2006/0253339 A1
(43) Pub. Date: Nov. 9, 2006

(54) System and process for escrow of payments

(76) Inventors: Moneet Singh, Conshohocken, PA (US); Neeraj Bansal, Philadelphia, PA (US)

Correspondence Address: Jeffrey Racho, Esq., 219 Righters Mill Rd., Ste. 200, Narberth, PA, 19072, US

(21) Appl. No.: 11/418,272

(22) Filed: May 4, 2006

Related U.S. Application Data
(60) Provisional application No. 60/677,967, filed on May 5, 2005.

(51) Int. Cl. G06Q 30/00

(52) U.S. Cl. 705/26

(57) ABSTRACT

Escrow services involve an escrow agent who facilitates an exchange between two parties, typically a payer and a payee. The “cash on delivery” (“C.O.D.”) service is akin to an escrow service, although carriers do not favor C.O.D. services due to their costs. The claimed invention is a method and system which provides an escrow service akin to a C.O.D. service, allowing a carrier to provide the equivalent of a C.O.D. service while shifting payment management to the escrow agent. The system embodying the claimed invention includes electronic devices facilitating electronic communications between the payer and the payee to the transaction. In one embodiment, such electronic communications are provided via the short message service (SMS) feature available on mobile phones and include a notification to the payee that the purchased item was successfully delivered and that the escrowed funds shall be released and delivered to payee.

### CROSS REFERENCE TO RELATED APPLICATIONS

This nonprovisional patent application claims the benefit of the filing date of provisional application 60/677,967, filed May 5, 2005, which is herein incorporated by reference.

### STATEMENT REGARDING FEDERALLY SPONSORED RESEARCH AND DEVELOPMENT

No Federally sponsored research or development was requested for, accepted, or used in the development related to the invention herein claimed.

### BACKGROUND OF THE INVENTION

Escrow services are services in which a third party (the “escrow agent”) facilitates the exchange of goods and consideration between two parties: a payer, or a party which has paid for the goods, and a payee, or the seller selling the goods and to whom the consideration is due. The escrow agent commonly takes possession of either the consideration from the payer or the goods from the payee. After the escrow agent takes possession of the goods or consideration (the “escrowed good or consideration”) from the escrowing party, the non-escrowing party is notified to deliver his/her goods or consideration to the escrowing party. Once the non-escrowed goods or consideration is successfully delivered to the escrowing party, the escrow agent releases the escrowed goods or consideration to the non-escrowing party. An escrow agent may also take possession of the goods or consideration from each party and will then deliver both the goods and consideration to the proper party.

The common “cash on delivery” (“C.O.D.”) service may be interpreted as an escrow service. A payer and a payee agree to an exchange of goods and cash. The payer deposits the goods with a carrier, who acts as an “escrow agent” by delivering the goods to the payee but will not finalize the delivery until the payee has given the requisite cash amount to the carrier, who then remits the cash to the payer. Carriers do not ordinarily enjoy providing C.O.D. services, however, as C.O.D. shipments require additional work on the part of delivery personnel and increase the time the delivery personnel must spend on the delivery of the item shipped C.O.D. Deliveries using C.O.D. also may be marked by losses of cash or checks, leading to lower revenue for the carrier.

Escrow services may be considered as a form of “insurance.” If the amount of trust between the payee and payer is low, they can use a trusted escrow agent to facilitate the transfer of goods and consideration. The escrow agent can also act as a trusted recipient who will ensure that the goods are delivered in their proper condition if the payer has not inspected the goods.

One problem facing payers and payees, however, is that they must place a level of trust in the escrow agent. Internet “scams” have occurred where a party posing as an escrow agent has taken advantage of such trust and successfully cheated one or both of the parties out of the goods or consideration upon its delivery to the dishonest agent. Escrow agents also add transaction costs to the exchange of goods and services between the payer and payee, making the transaction more expensive than it otherwise would be.

### BRIEF SUMMARY OF THE INVENTION

The claimed invention provides a method and system for the escrow of payments between two parties. This method and system will allow the payer to submit payment to a trusted third party who will escrow the funds. The payee will arrange shipment of the purchased goods through a common carrier. At the point of delivery, the payer will authenticate the delivery on an electronic device provided by the common carrier, or via an electronic device they own, at which point the escrowed funds will be released to the payee. Both the payee and payer will be notified that the transaction has been successfully completed through a wireless communication sent to their respective wireless communications devices.

The claimed invention thus provides a method and system by which a common carrier can provide an alternative to “cash on delivery” services. The disclosed method and system for the escrow of payments may be integrated with a carrier's systems, allowing the carrier to provide the equivalent of a C.O.D. while shifting payment management to the escrow agent operating the escrow system.

The system embodying the method claimed may take the form of using various electronic devices to facilitate electronic communications between the payer and the payee. In one embodiment, the short message service (SMS) feature available on mobile or cellular phones, or another form of wireless communication, is used to notify the payee that the purchased item was successfully delivered and that the escrowed funds shall be released and delivered to payee.

From time to time in this application, the invention may be referred to as a “Payment on Delivery System” (“POD System”), “Payment on Delivery Method” (“POD Method”) or “Payment on Delivery Process” (“POD Process”).

### BRIEF DESCRIPTION OF THE DRAWINGS

FIG. 1 illustrates the “Payment on Demand” method and system and is the preferred embodiment of the invention.

FIG. 2 illustrates the “Payment on Demand” method and system with integration with the shipper's information technology systems.

FIG. 3 illustrates a variant of the “Payment on Demand” method and system without integration with the shipper's information technology systems.

### DETAILED DESCRIPTION OF THE INVENTION

Description of the System Components:

The system claimed consists of a plurality of computers, including web servers and database servers, routers, electronic communications devices, and software programs designed to implement the methods and processes described below. The system may be scalable to meet the operating entity's needs as required. Such a system may be referred to as the “Payment on Delivery System” or “POD System.”

How to Make the Invention:

A person skilled in the arts of computer technology may make the POD System using typical “off-the-shelf” components including routers, servers, and electronic components available from any of a number of computer hardware manufacturers.

A person skilled in the arts of information technology, including database administration and Internet and other communications protocols, may develop software programs implementing the methods and processes claimed herein from any number of computer languages, such as Perl or PHP, running on any number of computer operating systems, such as Linux. Such software programs will embody the processes described below and operate on the POD System.

Operation of the Invention—the Methods and Processes:

The system manages physical objects and information, stored in physical storage media on the components of the system as described above, as described in this section. In the three embodiments of the claimed process, the POD System is operated by a third party, although those skilled in the art can adapt a merchant's information systems to act as a POD System.

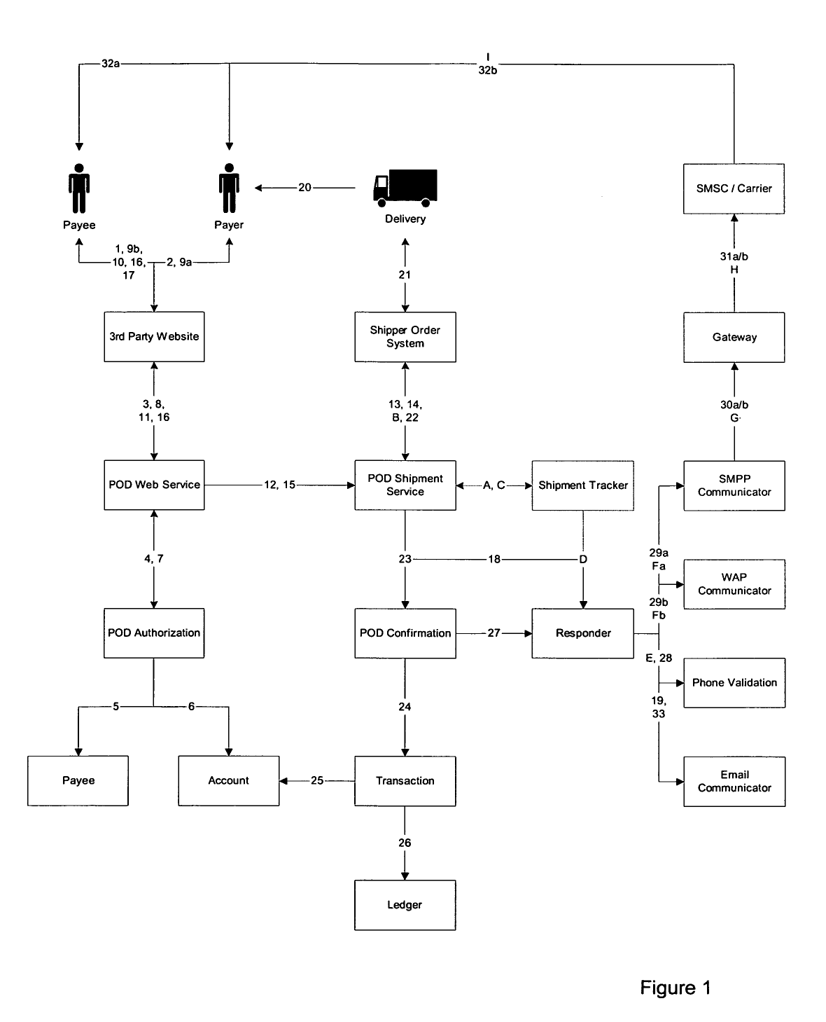

1) The “Payment on Delivery” Method (refer to steps in FIG. 1). FIG. 1 depicts the “Payment on Delivery” method, which in the Figure takes the form of an online transaction. The “Payment on Delivery” method need not solely take the form of an online transaction, however, as noted in the description below. The forms of electronic communication described in the method may vary in implementations of the method by those skilled in the arts of information technology. The steps describing the method below correspond to the alphanumeric labels on FIG. 1.

Step 1. In this embodiment of the claimed process, which is the preferred embodiment of the invention, a merchant, the “Payee” in the claimed process, enables a “Payment on Delivery” option for Payee's customers (the “Payers”). This option will use a POD System as described above to facilitate the payment from the Payer to the Payee. The “Payment on Delivery” option will result in an escrow of Payer's funds until the ordered item is successfully delivered to the Payer, upon which the funds are released to the Payee.

The POD System shall be configured to offer the Payee a large degree of flexibility during Step 1 of the process. If the Payee does not have an existing account with the party operating the POD System, the Payee can create one using the Internet or mobile phone which interacts with the POD System. The Payee can list its goods on a third party e-commerce, auction or other website, or on Payee's own website, so long as Payee makes the “Payment on Delivery” option available to its online customers. Furthermore, the Payee may offer its goods via a catalog, mail or phone order service, or in a showroom or retail environment for later delivery, or the goods may even be offered by a traveling salesman (who may not carry inventory) for later delivery. The “Payment on Delivery” method is not limited to online transactions so long as the POD System is configured to accept purchase notices from various forms of electronic communication, such as cell phones.

Step 2. The Payer orders an item from the Payee and selects “Payment on Delivery” as the payment mechanism. The Payer submits a user ID and password/confirmation code to the POD System either via the Internet, mobile phone, or some other form of electronic communication. For online transactions, the POD System may be served by the website facilitating the exchange, or said website may transfer the user to a website managed by the POD System. Should the Payer desire to use “Payment on Delivery,” but not yet have an account with the POD System, the Payer can create one prior to initiating the order from the Payee.

Step 3. For online exchanges, the website offering Payee's goods for sale, or the communications protocol facilitating the exchange between Payee and Payer, accepts and/or passes to the POD Web Service subsystem the following information: the Payer and Payee POD System account IDs and passwords; the total purchase amount; date/time; shipping from/to addresses and item shipping parameters (size, weight, special requirements, etc.). The Payer or Payee, or the Agent of Payer/Payee, can, however, directly enter the information into the POD system via phone/voice (such as through an interactive voice response (“IVR”) system), mail, Internet, Short Message Service (“SMS”), Multimedia Messaging Service (“MMS”), Wireless Application Protocol (“WAP”) or other wireless technology. Likewise, should a third party facilitating the exchange not be an online entity, the third party may directly enter the information into the POD System via phone/voice, mail, Internet, Short Message Service (“SMS”), Multimedia Messaging System (“MMS”), Wireless Application Protocol (“WAP”) or other wireless technology.

Step 4. The information submitted in Step 3 is passed to a verification subsystem, method or process of the POD System identified as the POD Authorization subsystem. If the parties to the transaction are using the Internet, the POD System will accept the information from a Web-based subsystem as depicted in FIG. 1.

Step 5. The POD System verifies the Payee using ID, password and/or other identification methods. The POD System may ask for additional verification of identity based on fraud detection/security programs/protocols. Additional authentication may be performed at this point.

Step 6. The POD System verifies the Payer account balance at another entity, such as a financial institution, and “guarantees” the finds in some manner, including, but not limited to: (1) by a hold or reservation of the purchase amount against the Payer account; (2) by a transfer of the purchase amount into a temporary third account; or (3) by a charge of the purchase amount against a credit/charge/debit or other external account and a transfer from this account into the Payer account or temporary third account. In this step, the account by which the described guarantee is effectuated is the “escrowed” account.

Steps 7, 8, 9a and 9b. The POD System provides a confirmation of the payment guarantee for the amount requested. The confirmation is forwarded to a subsystem, such as the POD Web Service subsystem, of the POD System, which then forwards it to a third party Website (or other electronic system as needed). The confirmation is then sent to the Payee by the third party; in the alternative, the POD System may send the confirmation directly to the Payee. The confirmation may be sent via phone/voice, mail, traditional internet, SMS, MMS, WAP or other wireless technology.

Step 10. After Payee receiving the confirmation that the funds have been guaranteed, the Payee notifies the third party facilitating the exchange, such as a third party website, or the POD System, that the shipment shall be a “Payment on Delivery” shipment. The Payee then submits an order for the shipment, or otherwise facilitates the shipment, of the purchased goods.

Steps 11, 12, 13, 14. The POD System receives and passes the “Payment on Delivery” shipment request and instructions to a carrier or shipper. The POD Shipment Service subsystem will submit an order for the shipment of the goods from the Payee to Payer's destination address to the carrier/shipper. The shipper may optionally verify the Payer's shipping address for confirmation purposes.

The POD System also passes a unique “Payment on Delivery (POD) Identifier” (which may be an alphanumeric code) to the carrier/shipper, who will associate this unique identifier to a package identifier (which may be an alphanumeric code). The shipper's order system will then submit shipping label information, including the package identifier associated with the unique POD Identifier, to the POD System. The package identifier and the POD Identifier may optionally be the same identifier code. The POD System associates these identifiers with a transaction identifier and the Payee/Payer identifiers in its data storage systems.

Steps 15-16. The POD Shipment Service subsystem accepts the shipping instructions and shipping label information, including a package identifier associated with the unique POD Identifier, and forwards it to the Payee, to Payee's agent, or to another responsible party (such as a shipping department).

Step 17. The Payee, Agent, or responsible party prepares the purchased goods for shipment using the shipping label information provided in Steps 15-16. The Payee, Agent or responsible party either (1) delivers the packaged and identified goods to the carrier/shipper; (2) directly accesses the carrier/shipper and requests a pick-up; or (3) orders a shipment pick-up from the carrier/shipper via the POD System, which passes the request to the shipper, who picks up the package.

Steps 18-19. Once the package is picked up by the carrier/shipper, an optional electronic confirmation message is sent to the Payee and Payer by the POD System. The POD System routes this message through its Responder subsystem which forwards the message via electronic communication methods. The confirmation message may take any number of forms of electronic communication, including email, SMS, MMS, or WAP.

Steps 20, 21, 22. The shipper delivers the package to the payer. The Payer, Payer's Agent, or a responsible party signs for or otherwise accepts delivery of the package. The Payer, Payer's Agent, or responsible party may accept the delivery by signing their name on an electronic handheld device such as the “STAR II/III” devices used by FedEx delivery personnel. Using the package identifier associated with the delivered goods, the shipper's electronic handheld device will update the status of the purchased goods as “delivered” on the Shipper's Order System. The POD System will then optionally associate the package identifier with the POD Identifier and will then submit the POD Identifier to the POD Shipment Service subsystem, thereby notifying the POD System that the goods have been properly delivered to and accepted by Payer. The POD System may, in the alternative, optionally look up and/or update the status of the package on the POD System and then notify the POD Shipment Service subsystem that the goods have been properly delivered to and accepted by Payer.

In the alternative to using the electronic handheld device in Steps 20-22, the shipper's delivery agent may send the POD Identifier via SMS, WAP, MMS or any other wireless protocol to the POD System.

Steps 23-24. Upon receiving the POD Identifier the POD Shipment Service subsystem notifies the POD Confirmation subsystem that the goods have been delivered to and accepted by Payer. The POD Confirmation subsystem releases the hold on the guaranteed funds and notifies its Transaction subsystem that the guaranteed funds have been released.

Steps 25-26. The Transaction subsystem looks up the Payee's account and calls upon the Ledger subsystem to deposit the funds into the Payee's account from the escrowed account described in Step 6. If the funds are held by another entity as described in Step 6, such as a financial institution, it is notified to release the funds into Payee's designated account as directed by the POD System. The Transaction subsystem may be operated by the entity holding the escrowed account, such as a third-party financial institution as described in Step 6.

Steps 27, 28, 29, 30, 31, 32, 33. The POD System optionally informs the Payer and Payee of the shipment's delivery, acceptance, and transfer of the funds from the escrowed account. This notice may take the form of email, SMS, WAP, MMS or any other wireless protocol.

Steps A, B, C, D, E, Fa, and Fb. During the process, after the goods have been delivered to the shipper as described in Step 17, the Shipper Order System will track the package. As the package's shipment status changes, the Shipper Order System may electronically transmit such changes to the POD Shipment Service subsystem. The package identifier (or POD Identifier if one identifier is used) will be used to identify the tracked package and identify the parties to the transaction. The POD Shipment Service subsystem may then communicate to the Payer and Payee the status of the package, including a notice to the Payer that the delivery of the package is imminent. These notices of the changes in the package's status may take the form of email, SMS, WAP, MMS or any other wireless protocol.

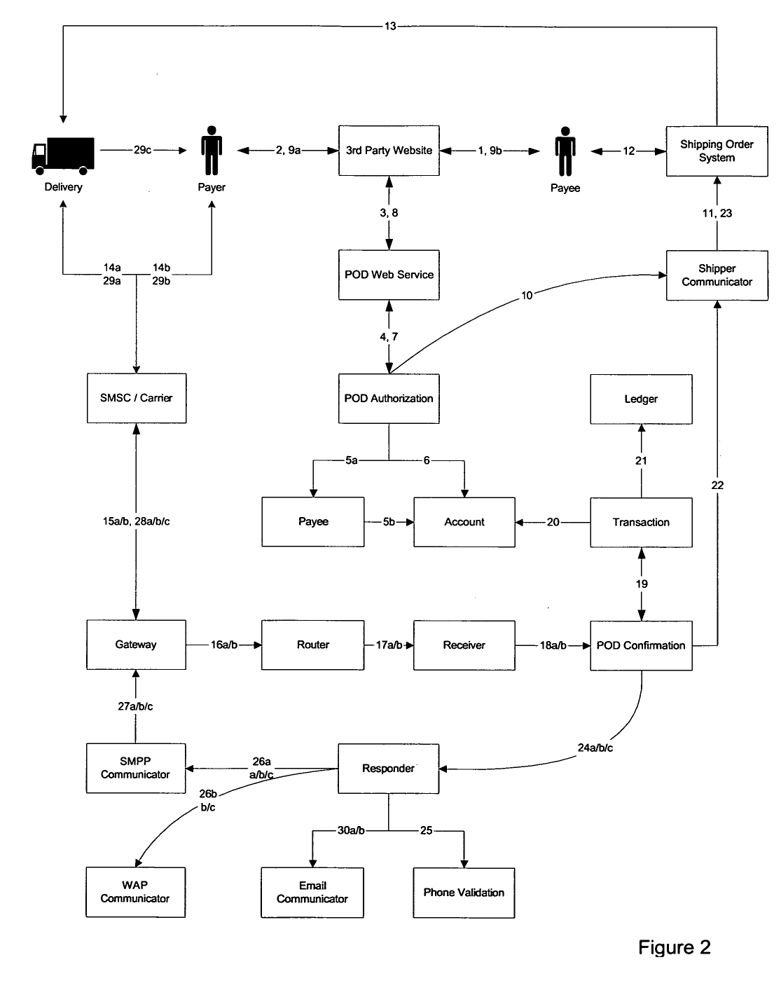

2) The “Payment on Delivery with Website and Shipper Integration” Method (refer to steps in FIG. 2). FIG. 2 depicts the “Payment on Delivery with Website and Shipper Integration” method, which in the Figure takes the form of an online transaction. This method need not solely take the form of an online transaction, however, as noted in the description below. This method is a derivative of Method 1, above, and its steps will reference the steps of Method 1 where the steps of Method 1 are equivalent or analogous to those steps of this Method 2. The forms of electronic communication described in the method may vary in implementations of the method by those skilled in the arts of information technology. The steps describing the method below correspond to the alphanumeric labels on FIG. 2.

Step 1. As fully described in Step 1 of Method 1, the Payee (seller) enables a “Pay on Delivery” option for an item for sale.

Step 2. As fully described in Step 2 of Method 1, the Payer (buyer) orders an item from the Payee and selects “Payment on Delivery” as the payment mechanism. The Payer submits a user ID and password/confirmation code to the POD System either via the Internet or some other form of electronic communication. The Payee may have a default shipper or carrier selected as the carrier which shall deliver the goods via the “Payment on Delivery” mechanism.

Step 3. As fully described in Step 3 of Method 1, the website offering Payee's goods for sale accepts and passes to the POD Web Service subsystem the relevant information.

Step 4. As fully described in Step 4 of Method 1, the information submitted in Step 3 to the POD Web Service subsystem is passed to a verification subsystem of the POD System identified as the POD Authorization subsystem.

Step 5. As described in Step 5 of Method 1, the POD System verifies the Payee using identification methods. Unlike Step 5 of Method 1, in Method 2 the Payee will have an account administered by the POD System; this account will be used to verify the identification of Payee. The Steps 5a and 5b may be separately performed to verify the identity of the Payee and to identify a path for the transfer of funds to the Payee's account.

Step 6. As described in Step 6 of Method 1, the POD System verifies the Payer account balance and “guarantees” the funds in some manner. In this step, the account by which the described guarantee is effectuated is the “escrowed” account. Unlike Step 6 of Method 1, in Method 2, the Payer account from which the funds are to be escrowed, as well as the escrowed account itself, may be administered by the POD System.

Steps 7, 8, 9a and 9b. As described in Steps 7, 8, 9a, and 9b of Method 1, the POD System provides a confirmation of the payment guarantee for the amount requested to the POD Web Service subsystem, which then forwards it to the third party Website, thereupon to the Payee. Additionally, the POD System sends a “Payment on Delivery (POD) Receipt Code” to the Payer and a “Payment on Delivery (POD) Confirmation Number” to the Payee via a communications protocol. The POD Receipt Code and POD Confirmation Number may take the form of an alphanumeric character string. The POD Authorization subsystem associates both the POD Receipt Code and POD Confirmation Number with an assigned transaction identifier and the Payee/Payer identifiers in its data storage systems.

Steps 10, 11. The POD Authorization subsystem sends a “Payment on Delivery (POD) Release Code” to the Shipper Communicator system of the shipper/carrier. The Shipper Communicator system then forwards the POD Release Code to the shipper's Shipping Order System.

Step 12. The shipper sends a delivery agent to Payee. Payee then remits the POD Confirmation Number to the agent, who submits it to the shipper's Shipping Order System, such as by using a handheld electronic device such as the FedEx “STAR II/III” unit. The Shipping Order System matches the POD Release Code to the POD Confirmation Number and gives the agent Permission to accept the package. The Shipping Order System associates both the POD Release Code and POD Confirmation Number with the package.

Step 13. The shipper's delivery agent arrives at the Payer's location and notifies Payer of its arrival.

Step 14a. The shipper's delivery agent submits the POD Release Code for eventual delivery to the POD System. As depicted in FIG. 2, the short message service (SMS) form of electronic communication is used for the transmittal of the POD Release Code to an SMS Carrier (SMSC). Note, however, as described in Steps 20-22 of Method 1, the POD Release Code may be sent via an electronic handheld device which is signed/authenticated by Payer or by another means of electronic communication.

Step 14b. Upon the arrival of the delivery agent, the Payer sends the POD Receipt Code for eventual delivery to the POD System via SMS. The SMS message carrying the POD Receipt Code is transferred to a SMSC. Note, however, the POD Release Code may be sent via another means of electronic communication.

Steps 15a, 16a, 17a, 18a. The POD Release Code is routed through the Gateway, Router, and Receiver subsystems of the POD System via the short message peer-to-peer protocol (SMPP), until the SMS message carrying the POD Release Code is delivered to the POD Confirmation subsystem of the POD System.

Steps 15b, 16b, 17b, 18b. The POD Receipt Code is routed through the Gateway, Router, and Receiver subsystems of the POD System via SMPP until the SMS message carrying the POD Receipt Code is delivered to the POD Confirmation subsystem of the POD System.

Steps 19, 20, 21. After receiving the POD Release Code and POD Receipt Code, the POD Confirmation subsystem confirms the association between the codes in its data storage systems, subsequently confirming the delivery of the package. After this confirmation, the POD Confirmation subsystem creates a request to release the funds escrowed in Step 6. The request is sent, via the Transaction subsystem of the POD System to the system administering the escrowed account. The escrowed account then transfers the funds to the Payee's account. The Ledger subsystem of either the POD System or the account administration system(s) is updated to reflect the transfer. The POD Confirmation subsystem then receives a confirmation of the transaction.

Steps 22, 23. The POD Confirmation subsystem optionally sends an electronic communication to the shipper's Shipper Communication system and Shipping Order System confirming the release of the escrowed funds.

Steps 24a/b/c. The POD Confirmation subsystem sends an electronic communication (which may take the form of an extensible markup language (XML) as depicted in the Figure) confirming the release of the escrowed funds to the Responder subsystem of the POD System.

Steps 25b, 25c. The Responder subsystem may send an electronic receipt confirming the release of the escrowed funds to the mobile phones of the Payer (25b) and Payee (25c).

Steps 26aa, 26ab, 26ac. The Responder subsystem sends an electronic communication confirming the release of the escrowed funds via SMPP to an SMPP Communicator system. The electronic confirmation is routed to be delivered to the delivery agent (26aa), to the Payer (26ab), and to the Payee (26ac).

Steps 26bb, 26bc. The Responder subsystem may send an electronic receipt confirming the release of the escrowed funds to the Payer (26bb) and Payee (26bc) via WAP.

Steps 27a, 27b, 27c. The SMPP Communicator system sends an electronic communication confirming the release of the escrowed funds via SMPP to the Gateway. The electronic confirmation is routed to be delivered to the delivery agent (27a), to the Payer (27b), and to the Payee (27c).

Steps 28a, 28b, 28c. The Gateway subsystem of the POD System sends an electronic communication confirming the release of the escrowed funds via SMPP to the SMS Carrier. The electronic confirmation is routed to be delivered to the delivery agent (28a), to the Payer (28b), and to the Payee (28c).

Steps 29a, 29b. The SMS Carrier delivers the SMS messages confirming the release of the escrowed funds to the delivery agent, Payer, and Payeee (not depicted). The delivery agent, upon receiving the notification that the funds have been released, delivers control of the package to the Payer. The Payer has also received notice of the release of the funds and accepts the delivered goods. The transaction is now complete.

Steps 30a, 30b. The Responder subsystem sends an email notification that the funds have been released and the package has been delivered via the Internet to the Payer and the Payee. This email may act as a final receipt of the transaction.

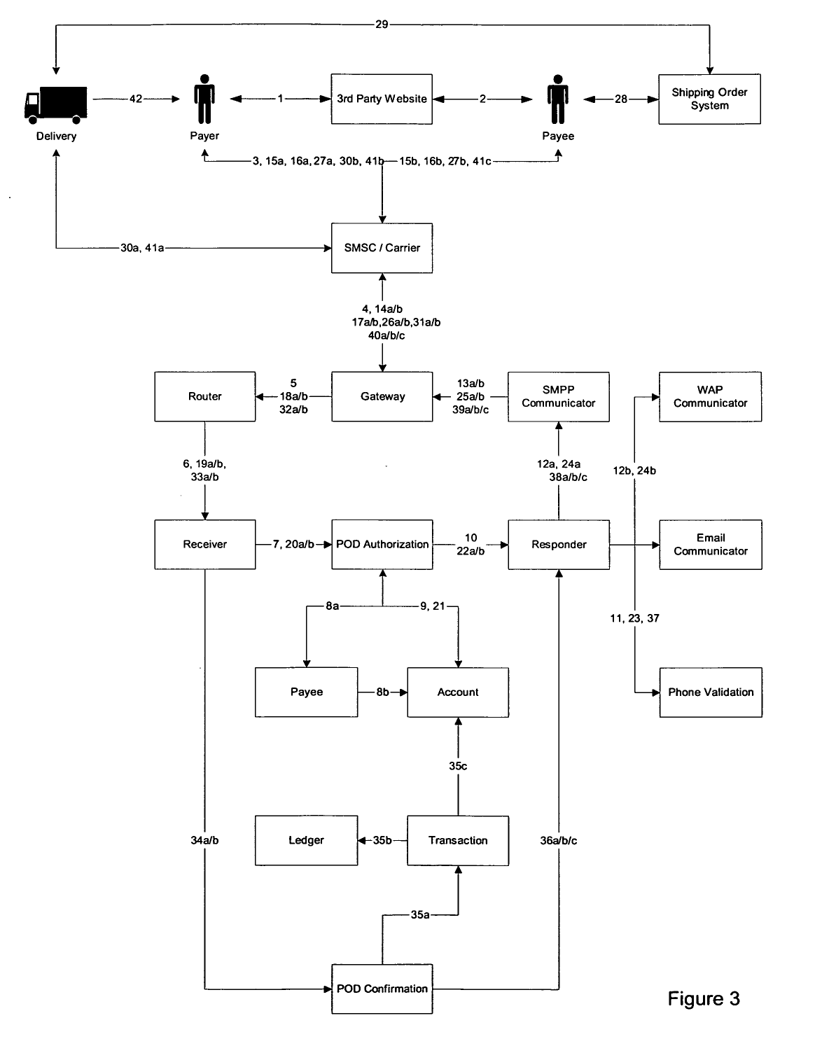

3) The “Payment on Delivery without Website or Shipper Integration” Method (refer to steps in FIG. 3). FIG. 3 depicts the “Payment on Delivery without Website Integration” method, which in the Figure takes the form of an online transaction. This method is a derivative of Method 2, above, and its steps will reference the steps of Method 2 where the steps of Method 2 are equivalent or analogous to those steps of this Method 3. The forms of electronic communication described in the method may vary in implementations of the method by those skilled in the arts of information technology. The steps describing the method below correspond to the alphanumeric labels on FIG. 3.

Step 1. As described in Step 2 of Method 2, the Payer (buyer) orders an item from the Payee and selects “Payment on Delivery” as the payment mechanism.

Step 2. The Payee confirms the order and submits its POD System user identification to the Payer via some form of electronic communication or other communication.

Step 3. The Payer sends an SMS message with the following information: (1) the Payee's POD System user identification; (2) the amount to be remitted to Payee; (3) the Payee's personal identification number (PIN) associated with Payee's account on the POD System; and (4) a request that a Payment on Delivery transaction is commencing between Payee and Payer. The SMS message is routed to an SMS Carrier.

Steps 4, 5, 6. The SMS message is delivered by the SMS Carrier to a Gateway, thereupon to a Router, thereupon to a Receiver, thereupon to a POD Authorization subsystem of the POD System.

Steps 8a, 8b, 9. The POD Authorization subsystem verifies the Payee's account at either another entity, such as a financial institution, or in Payee's account on the POD System. The POD Authorization subsystem also verifies the Payer account, including its account balance, at either another entity, such as a financial institution, or in Payer's account on the POD System.

Step 10. The POD Authorization subsystem delivers to a Responder subsystem two POD Confirmation messages addressed to the Payee and Payer. The POD Confirmation consists of a request confirming the identities of the Payee and Payer, the transaction amount, a transaction identifier, and that the transaction is to be a Payment on Delivery transaction.

Steps 11, 12b. The Responder may optionally choose to send the POD Confirmations via voice telephone communication, by email, or by WAP.

Steps 12a, 13a/b, 14a/b. Steps 12a, 13a/b, and 14a/b occur if the Responder sends the POD Confirmations via SMS. The POD Confirmations are sent from the Router subsystem, delivered to an SMPP Communicator subsystem, delivered to a Gateway subsystem, and thereupon to an SMS Carrier.

Steps 15a, 15b. The POD Confirmations are sent to the Payee and to the Payer.

Steps 16a, 16b. The Payee and Payer each confirm the POD Confirmations, replying with a POD Reply SMS confirming the POD transaction. The POD Reply is delivered to the SMS Carrier.

Steps 17a/b, 18a/b, 19a/b, 20a/b. The SMS messages containing the POD Replies from the Payer and Payee are delivered to and routed through the Gateway, Router, and Receiver subsystems of the POD System. The POD Replies are then delivered to the POD Authorization subsystem.

Step 21. The POD Authorization subsystem receives the replies and verifies the receipt of both replies, indicating that the Payer and Payee have confirmed the POD transaction. As described in Step 6 of Method 2, the POD System then “guarantees” the funds in Payer's account in some manner. In this step, the account by which the described guarantee is effectuated is the “escrowed” account. The Payer account from which the funds are to be escrowed, as well as the escrowed account itself, may be administered by the POD System.

Steps 22a, 22b. After the funds have been escrowed, the POD Authorization subsystem delivers a POD Receipt Code, addressed to the Payer, and a POD Release Code, addressed to the Payee, to the Responder. Both codes may take the form of an alphanumeric character string. The POD System associates both the POD Receipt Code and POD Confirmation Number with the transaction identifier and the Payee/Payer identifiers in its data storage systems.

Steps 23, 24b. The Responder may optionally choose to send the POD Receipt Code and POD Release Code via voice telephone communication, by email, or by WAP.

Steps 24a, s5a/b, 26a/b. Steps 24a, s5a/b, 26a/b occur if the Responder sends the POD Receipt Code and POD Release Code via SMS. The POD Confirmations are sent from the Router subsystem, delivered to an SMPP Communicator subsystem, delivered to the Gateway subsystem, and thereupon to an SMS Carrier.

Steps 27a, 27b. The POD Receipt Code is delivered to the Payer, and the POD Release Code is delivered to the Payee.

Step 28. The Payee submits a shipping request for the package to a shipper/carrier. The Payee then includes the POD Release Code on the shipment form or shipment label of the package.

Step 29. The shipper/carrier ships the package with the purchased goods to the Payer.

Steps 30a, 30b. Upon arrival at Payer's location, the shipper's delivery agent notifies Payer that the package has arrived. The Payer then sends an SMS message containing the POD Receipt Code to the POD System. The shipper's delivery agent reads the POD Release Code on the package's shipment form or shipment label and sends an SMS message with the POD Release Code to the POD System.

Steps 31a/b, 32a/b, 33a/b, 34a/b. The SMS messages containing the POD Receipt Code and the POD Release Code are delivered to and routed through the Gateway, Router, and Receiver subsystems. The POD Receipt Code and the POD Release Code are then delivered to the POD Confirmation subsystem.

Steps 35a, 35b, 35c. After receiving the POD Release Code and POD Receipt Code, the POD Confirmation subsystem confirms the association between the codes in its data storage systems, subsequently confirming the delivery of the package. After this confirmation, the POD Confirmation subsystem creates a request to release the funds escrowed in Step 21. The request is sent, via the Transaction subsystem of the POD System to the system administering the escrowed account. The escrowed account then transfers the funds to the Payee's account. The Ledger subsystem of either the POD System or the account administration system(s) is updated to reflect the transfer. The POD Confirmation subsystem then receives a confirmation of the transaction.

Steps 36a, 36b, 36c. The POD Confirmation subsystem sends to the Responder subsystem a group of electronic communications comprising (a) confirmations/receipts of the release of the escrowed funds and (2) a notice to the delivery agent instructing him/her to release the package to the Payer. The electronic communications are addressed for delivery to the delivery agent (36a), to the Payer (36b), and to the Payee (36c).

Step 37. The Responder subsystem may optionally choose to send the electronic communications of Steps 36a/b/c, above, via voice telephone communication, by email, or by WAP.

Steps 38a/b/c, 39a/b/c, 40/a/b/c. Steps 38a/b/c, 39a/b/c, 40/a/b/c occur if the Responder subsystem sends the electronic communications of Steps 36a/b/c, above, via SMS. The electronic communications are sent from the Router subsystem, delivered to an SMPP Communicator subsystem, delivered to a Gateway, and thereupon to an SMS Carrier.

Steps 41a, 41b, 41c. The SMS Carrier delivers the SMS messages containing the electronic communications of Steps 36a/b/c, above. The delivery agent receives notice that the package should be released to the Payer (Step 41a) while the Payer and Payee each receive a receipt confirming the release of the escrowed finds (Steps 41b, 41c). The delivery agent, upon receiving the notification, delivers control of the package to the Payer. The transaction is now complete.

I claim:

1. A method for the escrow of payment for and delivery of purchased goods, comprising the steps of:
a seller making said purchased goods available for sale, optionally through a third party facilitator;
a buyer entering into a contract for purchase of said purchased goods from said seller at an agreed-on total cost, optionally through said third party facilitator;
said buyer remitting a user identification and password to a computer system, optionally through said third party facilitator, via a first communication from said buyer, said first communication from said buyer optionally comprising additional personally identifiable information pertaining to said buyer;
said buyer and said seller, or optionally said third party facilitator, remitting information pertinent to said contract for purchase of said purchased goods to said computer system, said computer system thereby creating a transaction identifier and data record for said contract for purchase of said purchased goods;
said computer system performing a verification and authentication of said buyer's identity using information contained in said first communication from said buyer, said verification and authentication optionally using said additional personally identifiable information pertaining to said buyer;
said computer system electronically verifying that sufficient funds to complete said contract for purchase are held in said buyer's account at a financial institution, wherein said sufficient funds must be of an amount equal to that of said agreed-on total cost;
said computer system canceling said contract for purchase of said goods should said verification and authentication of said buyer's identity fail to properly identify said buyer, or should the balance of said buyer's account at a financial institution be insufficient to meet said buyer's obligation to remit said agreed-on total cost to said seller, thereupon said computer system electronically remitting a failure notice to said buyer, said seller, and optionally said third party facilitator;
said computer system guaranteeing said sufficient funds in said buyer's account at said financial institution by placing a hold command on said sufficient funds, thereby escrowing said sufficient funds for the benefit of said seller;
said computer system electronically remitting confirmation to said seller, said buyer and optionally to said third party facilitator that said sufficient funds have been escrowed in said buyer's account for the benefit of said seller;
said seller electronically remitting instructions for the delivery of said purchased goods to said computer system, optionally through said third party facilitator;
said computer system electronically remitting said instructions for the delivery of said purchased goods to a third party carrier;
said computer system optionally performing a verification and authentication of the physical address associated with said buyer, said physical address optionally electronically remitted to said computer system by said seller, said computer system canceling said contract for purchase of said goods should said verification and authentication verification and authentication of the physical address associated with said buyer fail to properly identify said buyer, thereupon said computer electronically remitting an address failure notice to said buyer, said seller, and optionally said third party facilitator;
said computer system electronically passing a unique identifier datum to said third party carrier, said unique identifier datum associated by said computer system with said transaction identifier, said buyer, said seller, said sufficient funds escrowed to said seller, and said physical address;
said third party carrier associating said unique identifier datum with the tracking identifier used by said third party carrier to identify and track shipped goods, said third party carrier optionally setting said tracking identifier equal in value to said unique identifier datum;
said third party carrier electronically forwarding said tracking identifier to said computer system, thereupon said computer system electronically forwarding said tracking identifier to said seller;
said seller affixing said tracking identifier to said purchased goods when preparing said purchased goods for shipment and remitting said purchased goods to said third party carrier;
said third party carrier electronically notifying said computer system that it has taken possession of said purchased goods, thereupon said computer system delivering an electronic notification to said buyer that said third party carrier has taken possession of said purchased goods;
said third party carrier optionally delivering electronic transit status messages indicative of the delivery status of said purchased goods to said computer system, thereupon said computer system electronically delivering delivery update messages to said buyer, said seller, and optionally said third party facilitator, said delivery update messages further comprising a message indicating that delivery of said purchased goods is imminent or expected within a pre-determined time frame as specified by said buyer, said seller, or optionally said third party facilitator;
said third party carrier delivering said purchased goods to said buyer, whereupon said buyer's acceptance of said purchased goods, said third party carrier electronically delivers a delivery notification message to said computer system, said delivery notification message including information associating said delivery notification message with said tracking identifier;
said computer system associating said tracking identifier with said unique identifier datum, thereupon associating said unique identifier datum with said transaction identifier, thereupon identifying said sufficient funds escrowed to said seller as the remuneration due to said seller, thereupon releasing said sufficient funds from escrow and directing said financial institution to remit said sufficient funds to said seller; and
said computer system electronically delivering a final notice to said buyer, said seller, and optionally to said third party facilitator, said final notice informing each recipient that said purchased goods have been delivered to said buyer and that said sufficient funds have been released from escrow and remitted to said seller.

2. The method of claim 1, wherein said computer system further comprises a server computer which hosts an Internet website, said computer system further acting in the role of said third party facilitator.

3. The method of claim 1, wherein said hold command on said sufficient funds takes the form of a transfer of an amount equal to said sufficient funds from said buyer's account at said financial institution to a temporary account at a designated financial institution, said sufficient funds being held in said temporary account until said computer system receives said tracking identifier from said third party carrier and thereupon releases said sufficient funds from said temporary account and remits said sufficient funds to said seller.

4. The method of claim 1, wherein said first communication from said buyer, said information pertinent to said contract for purchase of said purchased goods, said failure notice, said confirmation that such said sufficient funds have been escrowed in said buyer's account for the benefit of said seller, said address failure notice, said tracking identifier, said electronic notification to said buyer that said third party carrier has taken possession of said purchased goods, said delivery update messages, and said final notice to said buyer, said seller, and optionally to said third party facilitator are delivered by means selected from the group consisting of: messages using a telephone system, messages using an interactive voice response system, electronic messages sent over the Internet, electronic messages sent using the short message service (SMS), electronic messages sent using the multimedia messaging service (MMS), and electronic messages sent using the wireless application protocol.

5. The method of claim 1, where said additional personally identifiable information pertaining to said buyer identifies a mobile communications device from which said buyer remits said first electronic communication from said buyer.

6. The method of claim 1, where said financial institution is the financial institution which has issued a credit card to said buyer, manages a credit account for said buyer, or has issued a prepaid card account to said buyer.

7. The method of claim 1, where said remission of said sufficient funds to said seller takes the form of an electronic funds transfer to a financial account controlled by said seller or a check physically mailed to said seller.

8. A method for the escrow of payment for and delivery of purchased goods, comprising the steps of
a seller making said purchased goods available for sale, optionally through a third party facilitator;
a buyer entering into a contract for purchase of said purchased goods from said seller at an agreed-on total cost, optionally through said third party facilitator;
said buyer electronically remitting a user identification and password to a computer system, optionally through said third party facilitator, via a first communication from said buyer, said first communication from said buyer optionally comprising additional personally identifiable information pertaining to said buyer;
said buyer and said seller, or optionally said third party facilitator, remitting information pertinent to said contract for purchase of said purchased goods to said computer system, said computer system thereby creating a transaction identifier and data record for said contract for purchase of said purchased goods;
said computer system performing a verification and authentication of said buyer's identity, said verification and authentication optionally using said additional personally identifiable information pertaining to said buyer, said verification and authentication being performed against a data file which said buyer had previously created on said computer system prior to the commencement of said contract for purchase of said purchased goods;
said computer system electronically verifying that sufficient funds to complete said contract for purchase are held in an account controlled by said buyer, said account optionally being administered by the same entity which controls said computer system, wherein said sufficient funds must be of an amount equal to that of said agreed-on total cost;
said computer system canceling said contract for purchase of said goods should said verification and authentication of said buyer's identity fail to properly identify said buyer, or should the balance of said account controlled by said buyer be insufficient to meet said buyer's obligation to remit said agreed-on total cost to said seller, thereupon said computer system electronically remitting a failure notice to said buyer, said seller, and optionally said third party facilitator;
said computer system guaranteeing said sufficient funds in said account controlled by said buyer by placing a hold command on said sufficient funds, thereby escrowing said sufficient funds for the benefit of said seller;
said computer system electronically remitting confirmation to said seller, said buyer and optionally to said third party facilitator that said sufficient funds have been escrowed in said buyer's account for the benefit of said seller;
said computer system electronically remitting a payment on delivery receipt code to said buyer and a payment on delivery confirmation code to said seller, said payment on delivery receipt code and said payment on delivery confirmation code optionally taking the form of an alphanumeric string of characters, said payment on delivery receipt code and said payment on delivery confirmation code associated with said transaction identifier by said computer system;
said seller electronically remitting instructions for the delivery of said purchased goods to said computer system, optionally through said third party facilitator, thereupon said computer system electronically remitting said instructions for the delivery of said purchased goods to a third party carrier;
said computer system electronically remitting a payment on delivery release code to said third party carrier, said payment on delivery release code optionally taking the form of an alphanumeric string of characters, said payment on delivery release code associated with said transaction identifier by said computer system;
said computer system optionally performing a verification and authentication of the physical address associated with said buyer, said physical address optionally electronically remitted to said computer system by said seller, said computer system canceling said contract for purchase of said goods should said verification and authentication verification and authentication of the physical address associated with said buyer fail to properly identify said buyer, thereupon said computer electronically remitting an address failure notice to said buyer, said seller, and optionally said third party facilitator;
said seller arranging pickup of said purchased goods with a representative of said third party carrier;
said seller electronically remitting said payment on delivery confirmation code to said third party carrier, thereupon said third party carrier verifying said payment on delivery confirmation code against said payment on delivery release code before authorizing said representative to accept said purchased goods from said seller, said third party carrier refusing to accept said purchased goods should said payment on delivery confirmation code fail to correspond to said delivery release code, and said third party carrier associating said payment on delivery release code with said purchased goods;
said third party carrier's delivery person arriving at said buyer's physical location, thereupon said delivery person notifying said buyer of said delivery person's arrival, said delivery person thereupon electronically remitting said payment on delivery release code to said computer system;
said third party carrier optionally delivering electronic transit status messages indicative of the delivery status of said purchased goods to said computer system, thereupon said computer system electronically delivering delivery update messages to said buyer, said seller, and optionally said third party facilitator, said delivery update messages further comprising a message indicating that delivery of said purchased goods is imminent or expected within a pre-determined time frame as specified by said buyer, said seller, or optionally said third party facilitator;
said buyer, upon receipt of notification that said third party carrier's delivery person has arrived at said buyer's physical location, electronically remitting said payment on delivery receipt code to said computer system;
said computer system receiving said payment on delivery release code and said payment on delivery receipt code, thereupon said computer system verifying that said payment on delivery release code corresponds to said payment on delivery receipt code, said computer system electronically remitting a denial of delivery request to said third party carrier's delivery person should said payment on delivery release code and said payment on delivery receipt code not correspond to each other;
said computer system, should said payment on delivery release code and said payment on delivery receipt code correspond to each other, thereupon releasing said sufficient finds from escrow and remitting said sufficient funds to said seller, electronically remitting a delivery authorization notification to said third party carrier's delivery person,
said third party carrier's delivery person, upon receiving said delivery authorization notification, thereupon transferring said purchased goods to said buyer;
said computer system electronically delivering a final notice to said buyer, said seller, and optionally to said third party facilitator, said final notice informing each recipient that said purchased goods have been delivered to said buyer and that said sufficient funds have been released from escrow and remitted to said seller.

9. The method of claim 8, wherein said computer system further comprises a server computer which hosts an Internet website, said computer system further acting in the role of said third party facilitator.

10. The method of claim 8, wherein said first communication from said buyer, said information pertinent to said contract for purchase of said purchased goods, said failure notice, said confirmation that such said sufficient funds have been escrowed in said buyer's account for the benefit of said seller, said address failure notice, said electronic notification to said buyer that said third party carrier has taken possession of said purchased goods, said delivery update messages, said payment on delivery receipt code, said payment on delivery confirmation code, said payment on delivery release code, said delivery authorization notification, and said final notice to said buyer, said seller, and optionally to said third party facilitator are delivered by means selected from the group consisting of: messages using a telephone system, messages using an interactive voice response system, electronic messages sent over the Internet, electronic messages sent using the short message service (SMS), electronic messages sent using the multimedia messaging service (MMS), and electronic messages sent using the wireless application protocol.

11. The method of claim 8, where said additional personally identifiable information pertaining to said buyer identifies a mobile communications device from which said buyer remits said first electronic communication from said buyer.

12. The method of claim 8, where said remission of said sufficient funds to said seller takes the form of an electronic funds transfer to a financial account controlled by said seller or a check physically mailed to said seller.

13. The method of claim 8, where the step of said seller electronically remitting instructions for the delivery of said purchased goods to said computer system, optionally through said third party facilitator, thereupon said computer system electronically remitting said instructions for the delivery of said purchased goods to a third party carrier, is instead replaced by the step of said seller remitting instructions for the delivery of said purchased goods directly to a third party carrier, said purchased goods identified by said payment on delivery release code associated with said purchased goods by means of an identification method, said identification method optionally taking the form of a shipment label.

14. An information technology system, said information technology system comprising computers, server computers, electronic communications hardware, and networking equipment, said information technology system performing the steps performed by said computer system of claim 1.

15. An information technology system, said information technology system comprising computers, server computers, electronic communications hardware, and networking equipment, said information technology system performing the steps performed by said computer system of claim 8.

16. An information technology system, said information technology system comprising computers, server computers, electronic communications hardware, and networking equipment, said information technology system performing the steps performed by said computer system of claim 13.
